(19) United States
(12) Patent Application Publication
(10) Pub. No.: US 2013/0087096 A1
(43) Pub. Date: Apr. 11, 2013

(54) APPARATUS FOR APPLYING DYE MATERIAL ON AN ELECTRODE TO FORM A DYE-SENSITIZED SOLAR CELL

(71) Applicants: Hsiu-Po KUO, Taipei City (TW); Chun-Te Wu, New Taipei City (TW); Chia-Chang Lin, Zhongli City (TW)

(72) Inventors: Hsiu-Po KUO, Taipei City (TW); Chun-Te Wu, New Taipei City (TW); Chia-Chang Lin, Zhongli City (TW)

(73) Assignee: CHANG GUNG UNIVERSITY, Tao-Yuan (TW)

(21) Appl. No.: 13/493,438

(22) Filed: Jun. 11, 2012

(30) Foreign Application Priority Data
Oct. 7, 2011 (TW) 100136488

(51) Int. Cl. B05C 11/00; B05C 13/02; B05C 5/00; B05C 11/10

(52) U.S. Cl. 118/602; 118/600

(57) ABSTRACT

An apparatus for applying dye material on an electrode to form a dye-sensitized solar cell includes a rotary unit and an electrode holding unit disposed around the rotary unit. The rotary unit is rotatable about a rotary axis and includes a dye tank for receiving liquid dye therein and a dye breaking unit disposed around the dye tank. The dye tank permits flow of the liquid dye therein to the dye breaking unit. The dye breaking unit breaks the liquid dye flowing from the dye tank into liquid droplets that move in the dye breaking unit due to centrifugal force. The rotary unit permits the liquid droplets to exit therefrom. The liquid droplets exiting the rotary unit are propelled toward an electrode on the electrode holding unit during rotation of the rotary unit.

### CROSS-REFERENCE TO RELATED APPLICATION

This application claims priority of Taiwanese Application No. 100136488, filed on Oct. 7, 2011.

### BACKGROUND OF THE INVENTION

1. Field of the Invention

The invention relates to a dye applying apparatus, more particularly to an apparatus for applying dye material on an electrode to forma dye-sensitized solar cell. 2. Description of the Related Art

There are two types of conventional solar cells. One type is the solid-state semiconductor solar cell that is made from silicon, III-IV groups or II-VI groups compound. Another type is the thin film solar cell. Dye-sensitized solar cell (DSSC) is a kind of the thin film solar cells, which incorporates dyes, electrodes and electrolytes. The DSSC has become popular in recent years due to its ease of manufacture, relatively low cost and relatively large area.

In preparing electrodes for the DSSC, a working electrode substrate is provided with a layer of sintered semiconductor to form an electrode semi-product, which is then immersed in a liquid dye bath for 20-24 hours such that the dye molecules are absorbed onto the electrode semi-product via diffusion or Brownian motion of the dye molecules, thereby forming the electrode for the DSSC.

To enhance the amount of the dye absorption, the semiconductor layer is typically formed with a porous structure or a nanotube structure in order to enlarge the surface area for absorbing the dye molecules and enhance the photoelectric conversion efficiency of the resulting DSSC.

However, it is found that the semiconductor layer might peel off from the electrode semi-product due to long-term immersion in the liquid dye bath, which leads to contamination of the liquid dye and reduction in the photoelectric conversion efficiency of the resulting DSSC. The subsequent treatment and recovery of the liquid dye involve complicated tasks. Moreover, the cost of the liquid dye is relatively high.

### SUMMARY OF THE INVENTION

Therefore, the object of the present invention is to provide an apparatus for applying dye material on an electrode to form a dye-sensitized solar cell in a manner that the time period of the dye application process may be shortened and the cost of the dye material may be saved.

Accordingly, an apparatus of the present invention is for applying dye material on an electrode semi-product to form a dye-sensitized solar cell and includes a rotary unit and an electrode holding unit. The rotary unit is rotatable about a rotary axis, and includes a dye tank for receiving liquid dye therein and a dye breaking unit disposed around the dye tank. The dye tank is configured to permit flow of the liquid dye therein to the dye breaking unit. The dye breaking unit is configured to break the liquid dye flowing from the dye tank into liquid droplets that move in the dye breaking unit due to centrifugal force. The rotary unit is further configured to permit the liquid droplets to exit therefrom. The electrode holding unit is disposed around the rotary unit for holding the electrode semi-product. The liquid droplets exiting the rotary unit are propelled toward the electrode semi-product on the electrode holding unit during rotation of the rotary unit.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic cross-sectional view of a preferred embodiment of an apparatus according to the present invention; and

FIG. 2 is a schematic top view of the preferred embodiment of FIG. 1, showing a rotary unit and an electrode holding unit thereof.

### DETAILED DESCRIPTION OF THE PREFERRED EMBODIMENT

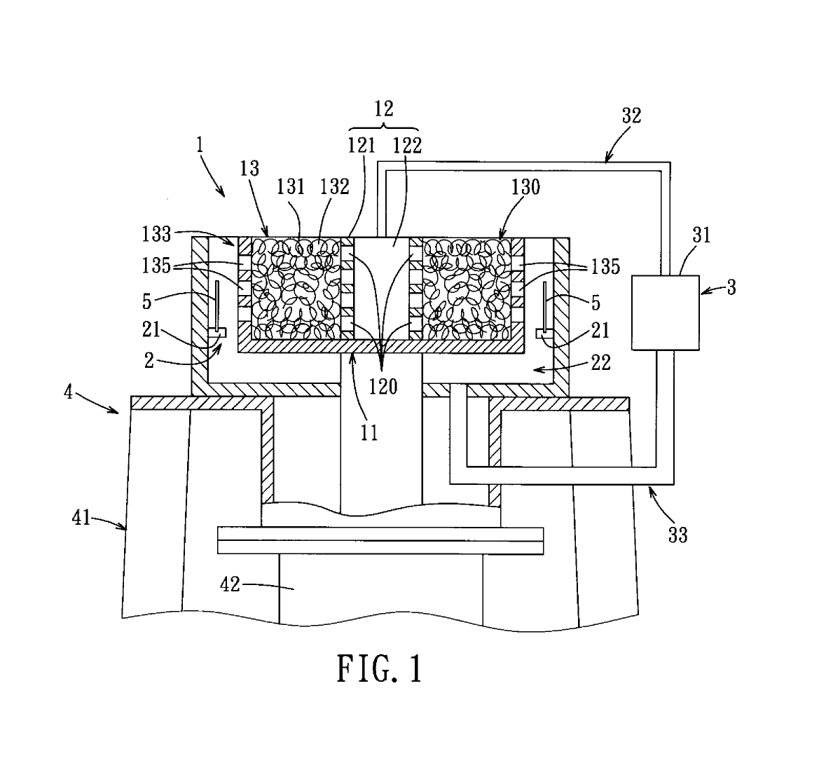

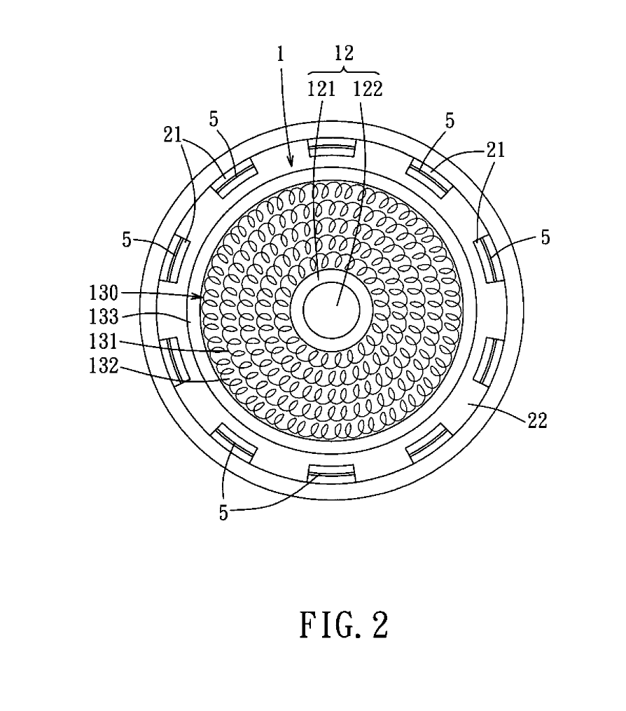

As shown in FIGS. 1 and 2, the preferred embodiment of an apparatus for applying dye material on an electrode to form a dye-sensitized solar cell (DSSC) according to the present invention includes a support unit 4, a rotary unit 1, an electrode holding unit 2, and a dye supply unit 3. With the use of the apparatus of the present invention, dye material can be sprayed onto electrodes 5 held on the electrode holding unit 2 so as to be absorbed by the electrodes 5 for use in performing photoelectric conversion in a DSSC.

The rotary unit 1 and the electrode holding unit 2 are supported on the support unit 4. The support unit 4 includes a support seat 41 and a power source 42 which is connected to the rotary unit 1 for providing rotary power to the rotary unit 1. The power source 42 is a motor in the present embodiment.

The rotary unit 1 includes a circular base wall 11 connected to the power source 42 so as to be driven by the power source 42 to rotate about a vertical rotary axis. A dye tank 12 is provided on the base wall 11 along the rotary axis. A dye breaking unit 13 is disposed around the dye tank 12.

The dye tank 12 includes an annular tank wall 121 extending upwardly from the base wall 11 and disposed around the rotary axis such that the base wall 11 and the tank wall 121 cooperatively confine a dye receiving space 122 for receiving liquid dye. The tank wall 121 is formed with a plurality of radial entrance holes 120 which configure the dye tank 12 to permit flow of the liquid dye therein to the dye breaking unit 13. Therefore, when the base wall 11 is driven by the power source 42 to rotate about the rotary axis, the liquid dye received in the dye tank 12 enters the liquid breaking unit 13 via the entrance holes 120 due to centrifugal force.

The rotary unit 1 further includes an annular surrounding wall 133 extending upwardly from a periphery of the base wall 11 and disposed around and spaced apart radially from the tank wall 121 such that an annular filler chamber 130 is defined among the tank wall 121, the surrounding wall 133 and the base wall 11. The dye breaking unit 13 includes at least one type of filler material 131 packed within the filler chamber 130 between the tank wall 121 and the surrounding wall 133 to form passageways 132 which are non-linearly communicated. The filler material 131 is selected from metal, alloy, organic polymer, inorganic material or combinations thereof and is non-reactive to the liquid dye. The filler material 131 may be in the form of sponges, webs, bulks, needles, pellets or spheres. Examples of the filler material 131 include, but are not limited to, entangled steel wool, iron wire netting and packed ceramic beads. The passageways 132 are arranged regularly or irregularly in the filler material 131. In the present embodiment, the filler material 131 is illustrated using steel wool. The passageways 132 of the filler material 131 configure the dye breaking unit 13 to break the liquid dye flowing from the dye tank 12 into liquid droplets that move in the filler material 131 due to centrifugal force.

The surrounding wall 133 is formed with a plurality of radial exit holes 135 which configure the rotary unit 1 to permit the liquid droplets that have passed through the filler material 131 to exit from the rotary unit 1 during rotation of the rotary unit 1.

The electrode holding unit 2 is disposed on the support seat 41 around the rotary unit 1 and includes a plurality of angularly spaced apart electrode holders 21 each configured for holding a corresponding electrode 5 that is to be used for forming a DSSC. The liquid droplets exiting the rotary unit 1 are propelled toward the electrodes 5 on the electrode holding unit 2 during rotation of the rotary unit 1 so as to be absorbed by the electrodes 5. A recovery tank 22 is disposed under the electrode holding unit 2 for collecting a part of the liquid droplets not absorbed by the electrodes 5.

The dye supply unit 3 includes a dye reservoir 31 for storing the liquid dye, a first transport unit 32 for transporting the liquid dye from the dye reservoir 31 to the dye tank 12, and a second transport unit 33 for transporting, such as by drawing, the liquid dye collected in the recovery tank 22 to the dye reservoir 31. In the present embodiment, the liquid dye is injected into the dye tank 12 in a direction along the rotary axis of the rotary unit 1 through the first transport unit 32.

In operation, the electrodes 5 to be applied with dye material are loaded respectively on the electrode holders 21. The power source 42 is then activated to drive rotation of the base wall 11, the dye tank 12 and the dye breaking unit 13. Simultaneously, liquid dye is transported from the dye reservoir 31 to the dye tank 12 via the first transport unit 32 and is injected into the dye tank 12 at a predetermined pressure. The liquid dye received in the dye tank 12 then flows from the dye tank 12 to the dye breaking unit 13 via the entrance holes 120 formed in the tank wall 121 and moves continuously through the filler material 131 due to centrifugal force during high speed rotation of the rotary unit 1. The liquid dye is broken down into liquid droplets of smaller sizes by the filler material 131 when moving through the latter. Under the action of centrifugal force, the liquid droplets then move continuously toward the surrounding wall 133 and exit the rotary unit 1 via the exit holes 135 formed in the surrounding wall 133. With the moment of inertia, the small-sized liquid droplets exiting the rotary unit 1 are propelled toward and collide with the electrodes 5 so as to be absorbed by the electrodes 5. A part of the liquid droplets which do not collide with the electrodes 5 or which are not absorbed by the electrodes 5 are collected in the recovery tank 22. The liquid dye collected in the recovery tank 22 is transported to the dye reservoir 31 via the second transport unit 33 for recycle.

Through the apparatus of the present invention, liquid dye is broken into liquid droplets of smaller sizes with moments of inertia and thus can be absorbed by the electrodes 5 with a relatively high efficiency. Moreover, the part of the liquid dye not absorbed by the electrodes 5 is collected and sent back to the dye reservoir 31. The liquid dye is thus prevented from contamination and is substantially recovered, thereby resulting in savings in the cost of dye material. In addition, the time period required for completing the dye absorption process is shorter than that for the conventional dye immersion process.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An apparatus for applying dye material on an electrode to form a dye-sensitized solar cell, comprising:
a rotary unit rotatable about a rotary axis, said rotary unit including a dye tank for receiving liquid dye therein and a dye breaking unit disposed around said dye tank, said dye tank being configured to permit flow of the liquid dye therein to said dye breaking unit, said dye breaking unit being configured to break the liquid dye flowing from said dye tank into liquid droplets that move in said dye breaking unit due to centrifugal force, said rotary unit being further configured to permit the liquid droplets to exit therefrom; and
an electrode holding unit disposed around said rotary unit for holding an electrode;
wherein the liquid droplets exiting said rotary unit are propelled toward the electrode on said electrode holding unit during rotation of said rotary unit.

2. The apparatus according to claim 1, wherein said dye tank has an annular tank wall formed with a plurality of radial entrance holes which permit flow of the liquid dye from said dye tank to said dye breaking unit.

3. The apparatus according to claim 2, wherein said rotary unit further includes an annular surrounding wall disposed around and spaced apart radially from said tank wall, said dye breaking unit including a filler material packed between said tank wall and said surrounding wall, said surrounding wall being formed with radial exit holes which permit the liquid droplets to exit from said rotary unit.

4. The apparatus according to claim 3, wherein said filler material is selected from the group consisting of metal, alloy, organic polymer, inorganic material and combinations thereof.

5. The apparatus according to claim 4, wherein said filler material is selected from the group consisting of steel wool, ceramic beads and the combination thereof.

6. The apparatus according to claim 1, further comprising a recovery tank disposed under said electrode holding unit for collecting liquid dye not absorbed by the electrode.

7. The apparatus according to claim 1, further comprising a dye reservoir for storing the liquid dye and a first transport unit for transporting the liquid dye from said dye reservoir to said dye tank.

8. The apparatus according to claim 7, further comprising:
a recovery tank disposed under said electrode holding unit for collecting a part of the liquid droplets not absorbed by the electrode; and
a second transport unit for transporting liquid dye collected in said recovery tank to said dye reservoir.

9. The apparatus according to claim 1, wherein said electrode holding unit includes a plurality of electrode holders each configured for holding a corresponding electrode thereon.
